(19) United States
(12) Patent Application Publication
(10) Pub. No.: US 2018/0268729 A1
(43) Pub. Date: Sep. 20, 2018

(54) 3-D Water Incident Simulation

(71) Applicant: DJS Associates, Abingdon, PA (US)

(72) Inventors: Thomas John Griffiths, State College, PA (US); Laurence Penn, Glenside, PA (US); Joy S. Falk, Meadowbrook, PA (US); Lauren Anne Latzko, Glenside, PA (US); Rachel Cayman Griffiths Jiannoni, Hermosa Beach, CA (US)

(73) Assignee: DJS Associates, Abington, PA (US)

(21) Appl. No.: 15/899,633

(22) Filed: Feb. 20, 2018

Related U.S. Application Data
(60) Provisional application No. 62/472,520, filed on Mar. 16, 2017.

(51) Int. Cl. G09B 9/00; G09B 5/06

(52) U.S. Cl. CPC G09B 9/006; G09B 5/065

(57) ABSTRACT

System and methods are provided for three-dimensional simulation of a water environment in which one or more individuals are positioned in or around the water environment and then randomly presented in actual or potential distress situations. One embodiment includes means for presenting a random water environment with one or more random individuals presented in actual or potential distress situations, means for permitting a system user to call attention to when the one or more individuals are in an actual or potential distress situation, and means for detecting the response time from when the actual or potential distress situation begins to when the user calls attention to the one or more individuals in such an actual or potential distress situation.

This application is a non-provisional application claiming priority to provisional application U.S. Ser. No. 62/472,520, filed Mar. 16, 2017, the entire contents of which are incorporated herein by reference.

### BACKGROUND

The present invention relates to 3-D water simulation in general, and in particular, the implementation of a skills assessment simulator that generates water environments for one or more individuals and scores users of the simulator on their ability to detect potential victims of drowning or harm.

Life guards are traditionally put through significant training on the ability to spot swimmers in danger and to execute rescue procedures in sufficient time to prevent drownings. Great focus is often placed on the rescue procedures. However, there are dangerous water situations in which the victim may appear a first glance to be safe when actually the situation is more risky than perceived. For example, many swimmers like to swim in shallow water holding their breath. The first impression is that the swimmer is fine. However, drownings do occur in which competent swimmers push themselves beyond their own capabilities. The life guard does not react because the swimmer never appears to be in danger until it's too late. A training module that addresses the less pronounced dangers is, therefore, needed to train life guards when seemingly benign situations turn critical, or life threatening.

### SUMMARY

In one embodiment, a system is provided for three-dimensional simulation of a water environment in which one or more individuals are positioned in or around the water environment and then randomly presented in actual or potential distress situations, where, for example, the system comprises means for presenting in three-dimensions a random water environment with one or more random individuals presented in actual or potential distress situations, means for permitting a system user to call attention to when the one or more individuals are in an actual or potential distress situation, and means for detecting the response time from when the actual or potential distress situation begins to when the user calls attention to the one or more individuals in such an actual or potential distress situation, wherein the system is configured so that one or more random water environments can be presented and wherein the system is configured to measure and report appropriate response times, permitting the system to be used not only as a game but as a training module for life guards. In one embodiment, the water environment is one of a pool or natural water body. In one embodiment, the permitting means comprises a blow-whistle button that can be depressed or clicked. In one embodiment, the detecting means comprises a clock visible to the user. If desired, some embodiments may comprise means for providing a score commensurate with the user's detection or lack of detection of an actual or potential distress situation and the elapsed time.

In other embodiments, a method is presented of providing a simulation of a critical incident in a water environment, where for example the method comprises presenting in three-dimensions a random water environment with one or more random individuals presented in actual or potential distress situations, permitting a user to call attention to when the one or more individuals are in an actual or potential distress situation, and detecting the response time from when the actual or potential distress situation begins to when the user calls attention to the one or more individuals in such an actual or potential distress situation, wherein the simulation is configured so that one or more random water environments can be presented and wherein the simulation is configured to measure and report appropriate response times, permitting the simulation to be used not only as a game but as a training module for life guards. In one embodiment, the water environment is one of a pool or natural water body. In one embodiment, permitting comprises providing a blow-whistle button that can be depressed or clicked. In one embodiment, detecting comprises providing a clock visible to the user. If desired, the method embodiments may further comprise providing a score commensurate with the user's detection or lack of detection of an actual or potential distress situation and the elapsed time.

### BRIEF DESCRIPTION OF THE FIGURES

The aforementioned objects and advantages of the present invention, as well as additional objects and advantages thereof, will be more fully understood hereinafter as a result of a detailed description of a preferred embodiment when taken in conjunction with the following drawings in which:

FIG. 1 shows a perspective elevational view of one embodiment of the present invention;

FIGS. 2A-2F show perspective elevational views of one simulation presented by the embodiment of FIG. 1;

FIGS. 3A-3E show perspective elevational views of another simulation presented by the embodiment of FIG. 1.

### DETAILED DESCRIPTION OF CERTAIN EMBODIMENTS

A 3-D lifeguard simulation game is provided built upon, in one embodiment, a Unity™ Game engine platform, which combines 3D geometry files, animations, audio, 2D graphics and interactive script programming (javascript or C#) into an exportable file that can then be distributed to users with compatible systems or devices. The game can be played on desktop computers and video game consoles as well as smartphones and tablets.

A user interface and menu images are provided that allow the user to navigate through the game. Such interface and menu images are created, in one embodiment, in Photoshop™ and exported as common image formats such as JPG or PNG and imported into Unity™. Custom scripting and programming is written to animate and give the menu functionality. In one embodiment, hard surface 3D models such as swimming pool basins, pool decking, buildings and furniture are either modeled in 3D Studio Max™ or can be acquired under commercial license from third parties. The 3D human models incorporated into the game are modeled in 3D Studio Max™ or generated using third party applications such as Adobe Fuse™ and Adobe Mixamo™ under commercial license. Animations of the human characters are also either animated in 3D Studio Max™ or generated from the Mixamo™ platform. The water surface and its attributes are derived from a third party “asset” purchased via the Unity Asset Store™, which is integrated into the Unity gaming platform. Music and sound effects can be acquired under commercial license from third parties and imported into the Unity™ platform. Playback is controlled via custom scripting.

With some embodiments, a networked system can be used to track user progress and scoring. The system will allow organizations with varying access levels to track registered users and create reports of relevant data. The data will also be available for research of relevant metrics. The system will be accessible outside of the game itself by authorized accounts.

In some embodiments, after navigating through simple menus to select the type of game play, a user is placed at a swimming pool environment in first person perspective. To simulate looking around the environment, the user can use on-screen controls, mouse, keyboard or physical movement of the device itself, should it be equipped with a gyroscope or similar motion-sensing technology. Using an interactive menu system, the user can also change their point of observation to pre-determined locations around the pool environment. The user is tasked with observing the environment and looking for individuals in or around the pool that may be in distress. The user should also notice defined “Critical Incidences” which are unsafe situations that could lead to personal injury or harm. The user can select an individual they think may be in distress, which can trigger a pre-programmed response assessing the user's actions, such as the time elapsed during game-play or the circumstances relating to the specific individual. In addition to the individuals that are simulated as drowning or participating in critical incidences, other individuals are placed in the environment to visually distract the user from their observational duties.

The simulated physical characteristics of the water such as reflectivity, cloudiness, surface ripples, and color are dynamic and programmed so that each scenario will be randomized and slightly different to avoid repetition of conditions from a previous session. Water conditions can be randomized as well, including large and small waves. When appropriate, the simulated sun direction and orientation as well as sky cover will be randomized to prevent repetition of environmental conditions. For indoor pool scenarios, artificial lighting conditions will also be variable for each location. It is contemplated that the type of individual, whether child, adult or elderly, can be presented and randomized as well, including skin tones, hair color, and clothing color.

In one example of a game demo mode, a basic water environment is provided where one or more individuals in and around the pool are presented either swimming, playing, standing around, etc. The user looks around the environment either from a static position, or can navigate via menu selection to different observation points around the pool. No drowning scenarios are demonstrated in the demo mode as it is merely intended to help the user to get used to the simulator and the environment.

In one example of a game play, a randomized pool environment is provided with randomized environmental conditions. Then one or more randomized drowning or critical incidence scenario is provided while the user observes to such critical incidents or drownings. The user is directed to take proactive action by selecting the individual in distress and the session ends, with the time it took for selection recorded to reflect how quickly the user reacted to the distress situation. The user can then replay the game using the same pool environment or environmental conditions, or different pool environment or environmental conditions. In each case, the ability to detect an individual in a critical incidence or in distress is monitored, along with the time it took for the user to detect such individual. A score is developed based upon detection and time. But importantly, it is not just the score that matters, but the ability of the user to learn to detect critical incidences or persons in distress.

In some embodiments, drowning simulations are presented, such as a playing swimmer that dips below water surface but doesn't resurface, a lap swimmer suddenly stops and doesn't resurface, an individual slips into the pool from the pool edge and doesn't resurface, a swimmer is in distress as they are out of depth, an individual jumps from diving board and doesn't resurface, or an aquasizer faints and doesn't resurface. Shallow and deep water variations of the above are also preferably presented. In some embodiments, critical incidences are presented, such as an individual holding their breath, more than one person on a diving board, children running around the pool, individuals engaging in chicken fights, etc. Both drowning situations and critical incidences are presented in embodiments of the present invention that task a user with detection and response time.

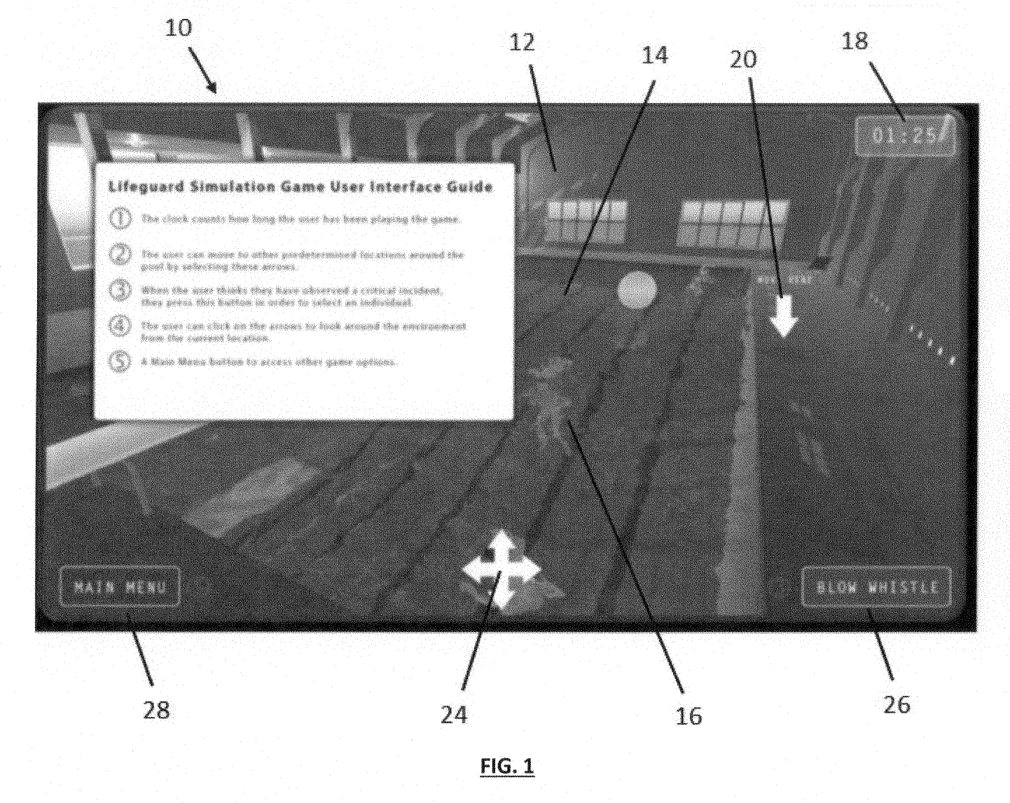

By way of example, and referring to FIG. 1, one example of one embodiment of the present invention can be described with reference to exemplary functionality and graphic user interface. In this particular simulator embodiment 10, a water environment 12 is presented in the form of an indoor pool 14 in which several people 16 are positioned in various modes of recreation. It should be noted that an outdoor pool or natural water body may also be depicted.

As shown by example in FIG. 1, in one embodiment, certain functional features are provided that provide information and/or permit customized perspective for the user. For example, a clock 18 may be provided to record the passage of time elapsed during operation of the simulator. The clock provides information about the amount of time that elapses between the start of an event, such as a critical incident, and a user's response to the event.

As another example, a position locator 20 is provided that permits the user to move to a different location within the water environment 12. The user need merely move the arrow to the desired location and then click or tap on the arrow so that the displayed view of the water environment 12 is from the new desired location. FIG. 1 shows the simulator user located at the deep end of the indoor pool 14 toward one corner (the corner at the user's right hand). The view perspective of the user at any one desired location can be manipulated by the 2-dimensional arrow 24, which mimics the movement of the user's head up and down or sideways, or simply movement of the eyes scanning the water environment 12. Between the position locator 20 and the view perspective arrows 24, the user is permitted 3-dimensional movement within the water environment 12.

One option provided in an embodiment of the simulator 10 is a feature that permits the user to call attention to a perceived event, such as a potential or critical incident. In one example, the feature is a “blow whistle” interface 26 that can be clicked or tapped to signify that the user has spotted an event that may reflect danger to one of the people 16 and/or a critical incident. Of course the interface 26 could be one of several different formats, including a buzzer or some other indicator that the progress of the simulation should discontinue. Further description of options associated with this feature is presented below.

A menu 28 of options is preferably provided to permit the user to select from one or more options associated with one or more water environments, as suggested above. The number of options and the type of options can vary from embodiment to embodiment, and within user-selected simulations for each embodiment, including, for example, which water environment is displayed, the number of people placed within the environment, how the environment is displayed, etc. Embodiments of the invention, however, include randomization programming that still presents the user with a unique scenario regardless of the options selected, so that the user's experiences in different settings are maximized.

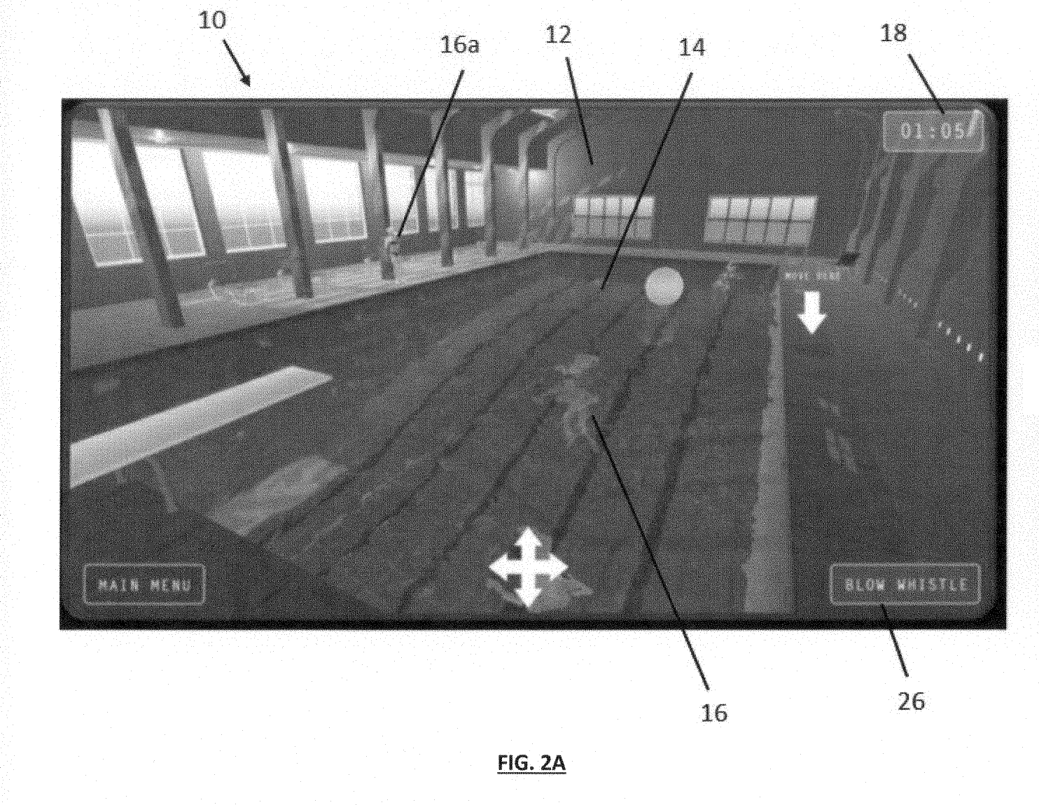

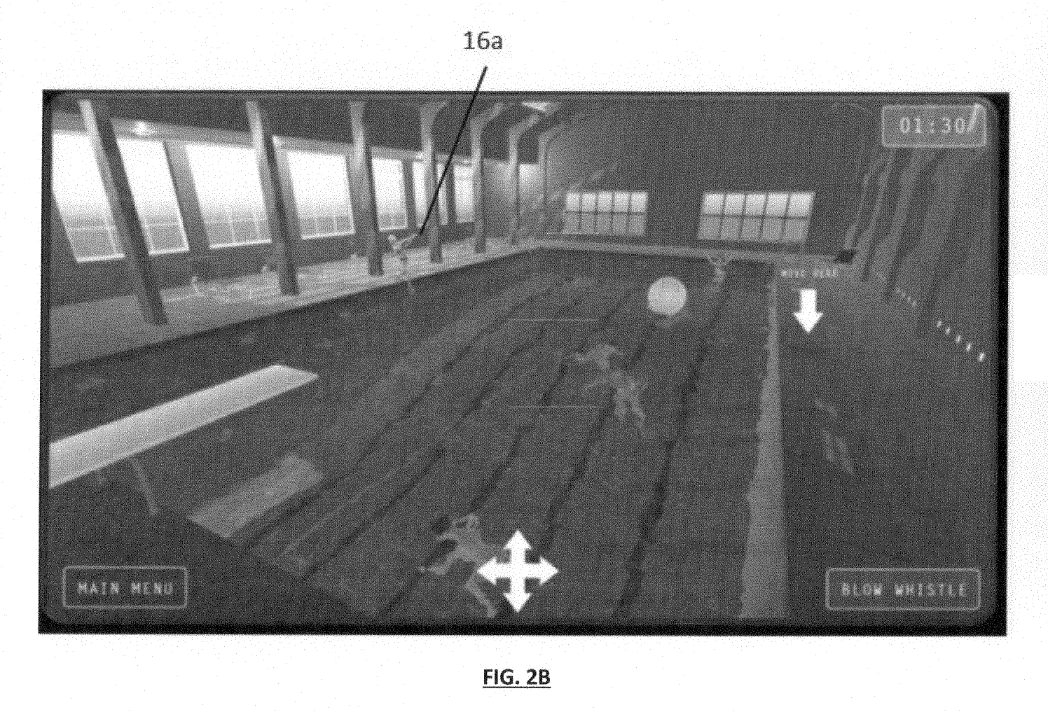

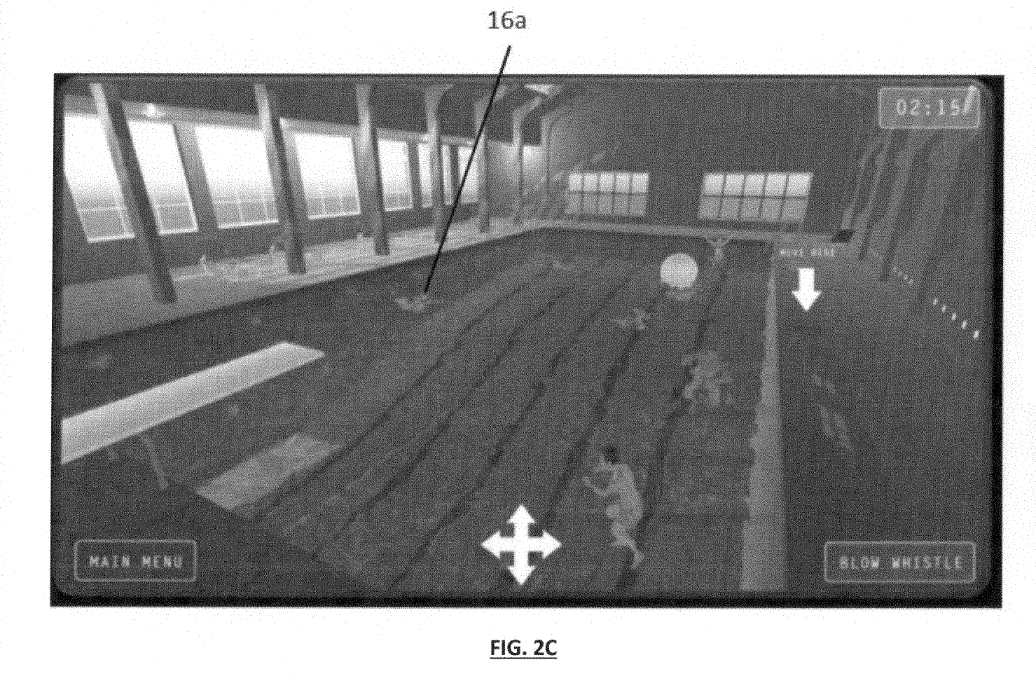

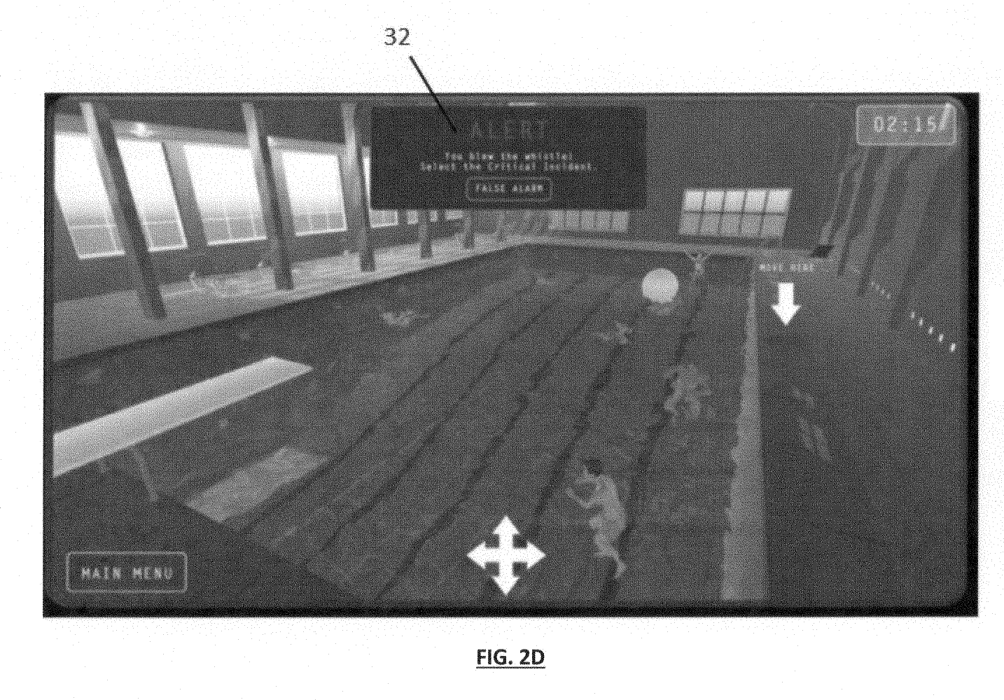

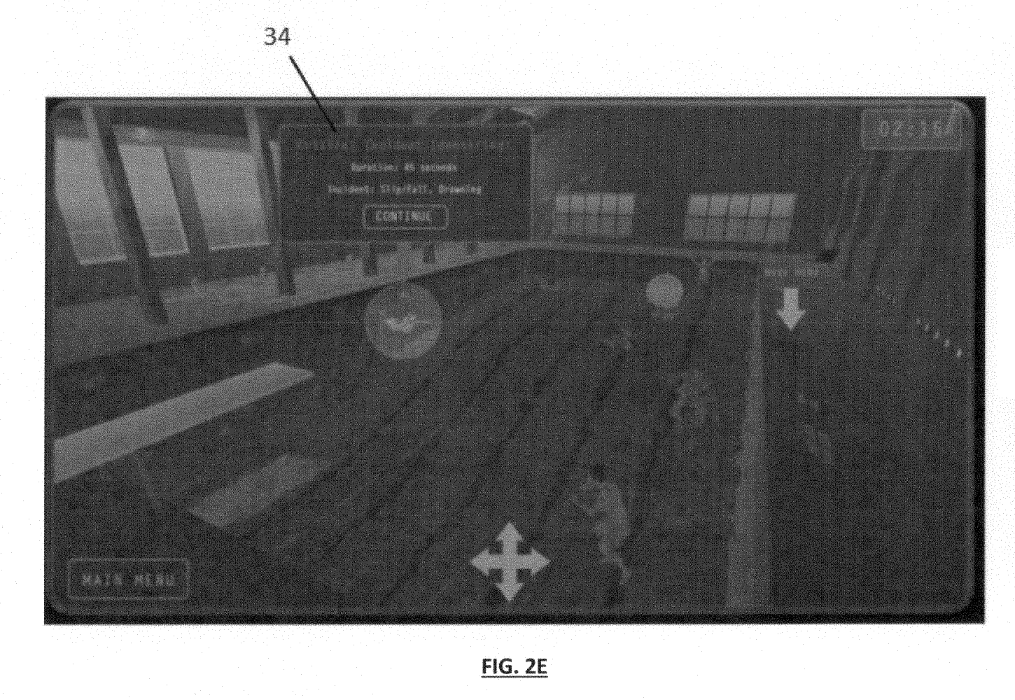

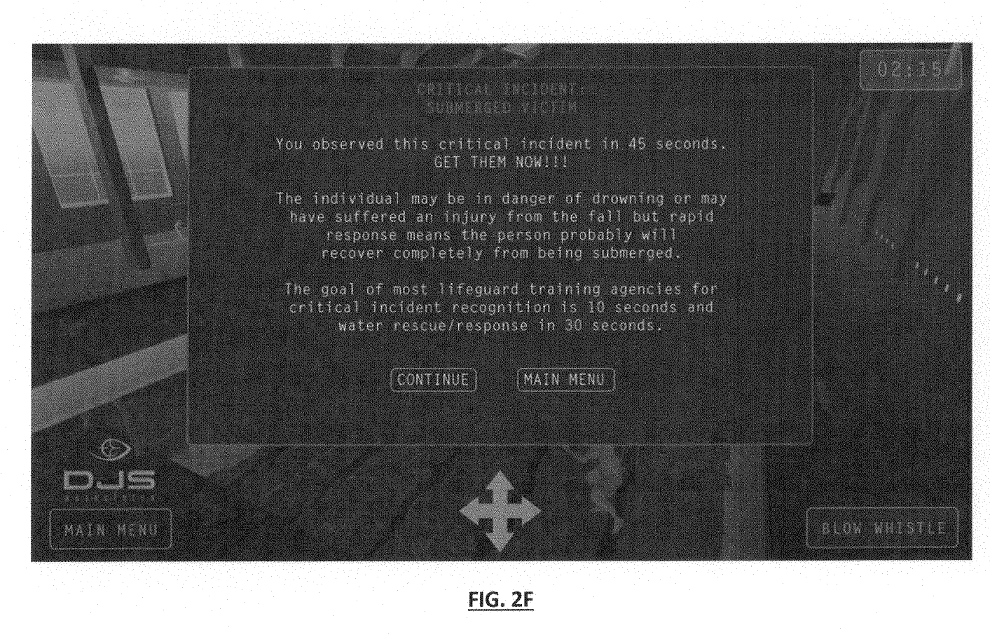

Referring to FIGS. 2A through 2F, one example of a sequence of use may be described to show how embodiments of the simulator may be used. In this particular example of FIG. 2A, the indoor pool 14 of water environment 12 is presented with five individual people 16 shown, including one individual 16a shown standing out of the water by the pool. At time 1:05 (as shown on the clock), individual 16a is standing at the edge of the left middle of the pool (from the user's perspective). As shown in FIG. 2B, at time 1:30, individual 16a jumps (or falls) into the pool, while the other individuals continue with their recreational activity. This could reflect an actual or potential distress situation; i.e., an unsafe or critical incident. Referring to FIG. 2C, individual 16a is shown underwater at time 2:15, which is 45 seconds since she entered the pool. The elapsed time signifies to the user that something may be wrong, i.e., an unsafe or critical incident may be occurring, The user can then press the “blow whistle” button 26 calling attention to an event. As shown in FIG. 2D, the user is then offered an opportunity in the form of an alert 32 user interface to call off the whistle as a false alarm or to point to the event that caused the user to be alerted; in this case, individual 16a.

Referring to FIG. 2E, the individual 16a is shown selected by the user, with information 34 optionally provided, including the time elapsed since the event began, and what type of event was simulated; in this case a time of 45 seconds, and an incident of slip/fall and drowning. An option to continue may be provided that provides the user with an assessment of whether the time elapsed was acceptable and the consequences of the event. For example, referring to FIG. 2F, feedback may be provided that, for example, indicates that the elapsed time was unacceptable and that injury may have resulted. A commensurate score may be indicated in some embodiments that reflects how effective the user was at identifying the unsafe or critical incident. The user may then continue, for example, with either the present simulation or select a new simulation. In this regard, the simulation provides educational and training benefit to the user.

It is contemplated that an option may be provided that alerts the user to the presence of an unsafe or critical incident without specifying which individual is at risk. The option may be configured to be turned on or off, depending upon whether the user wants the feature activated, and can be in the form of a visual or audible alert. For example, an audible sound may be provided that gets progressively louder as the unsafe or critical incident continues, or a flashing light may be provided that flashes more quickly as the unsafe or critical incident continues. Any score provided once the simulation has run its course can be indicated as an “assisted” score, for example.

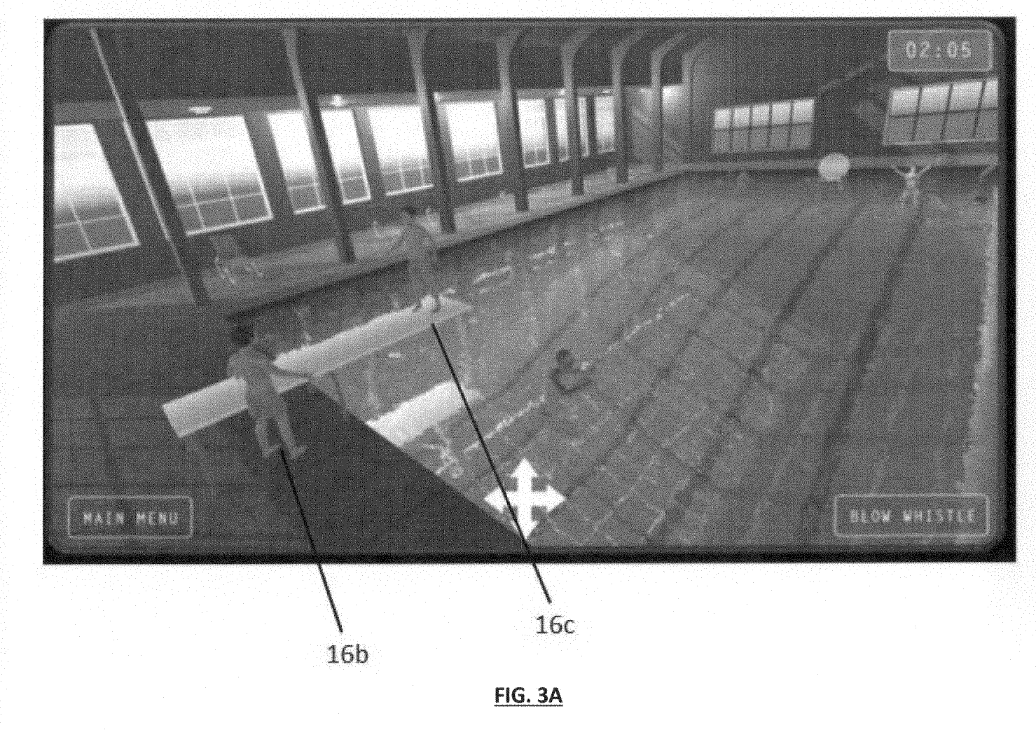

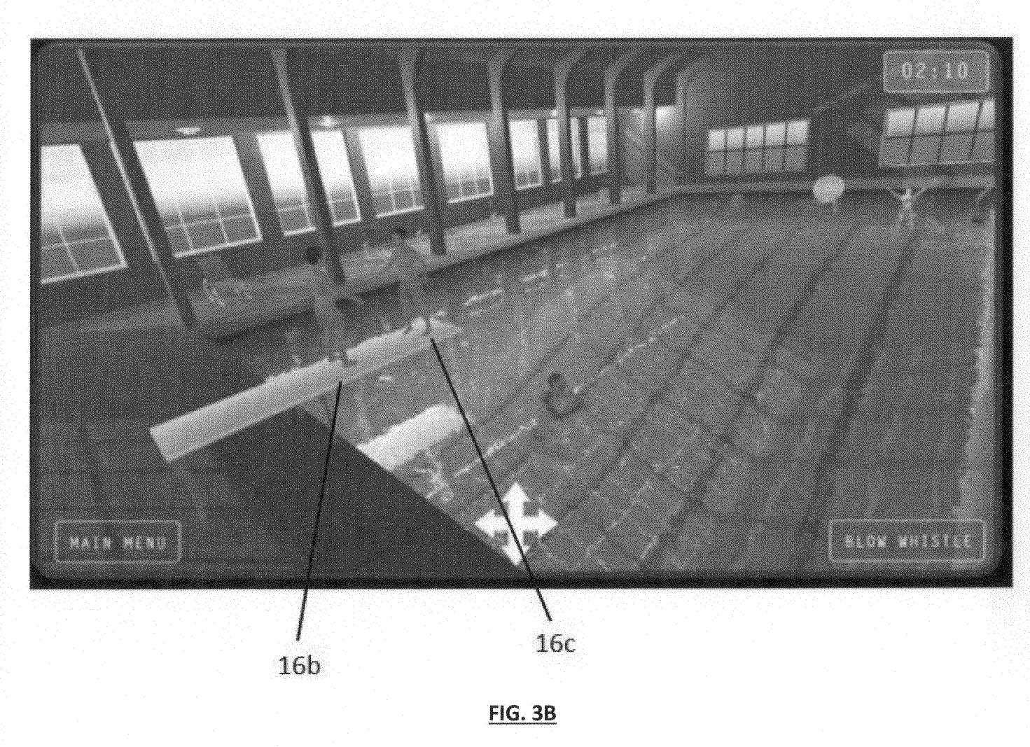

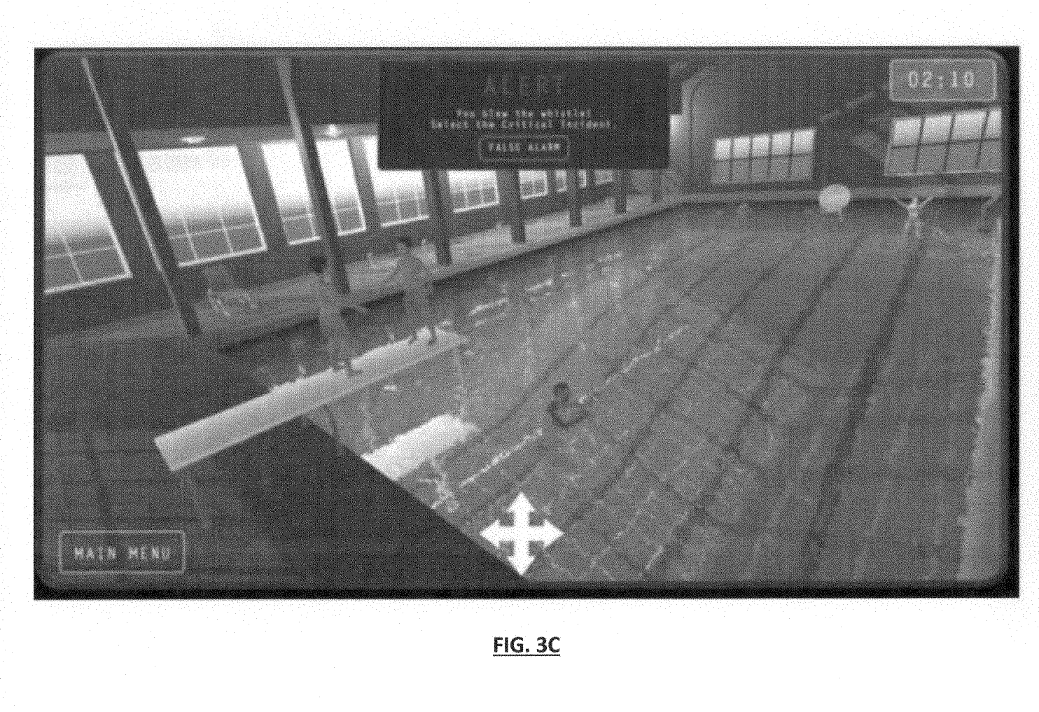

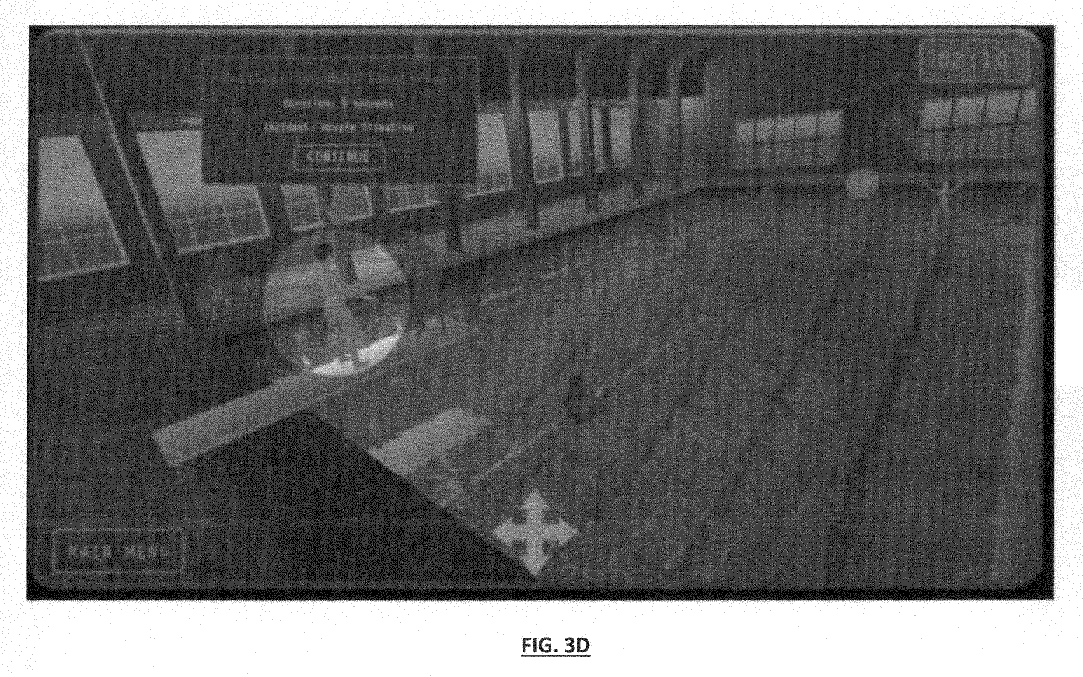

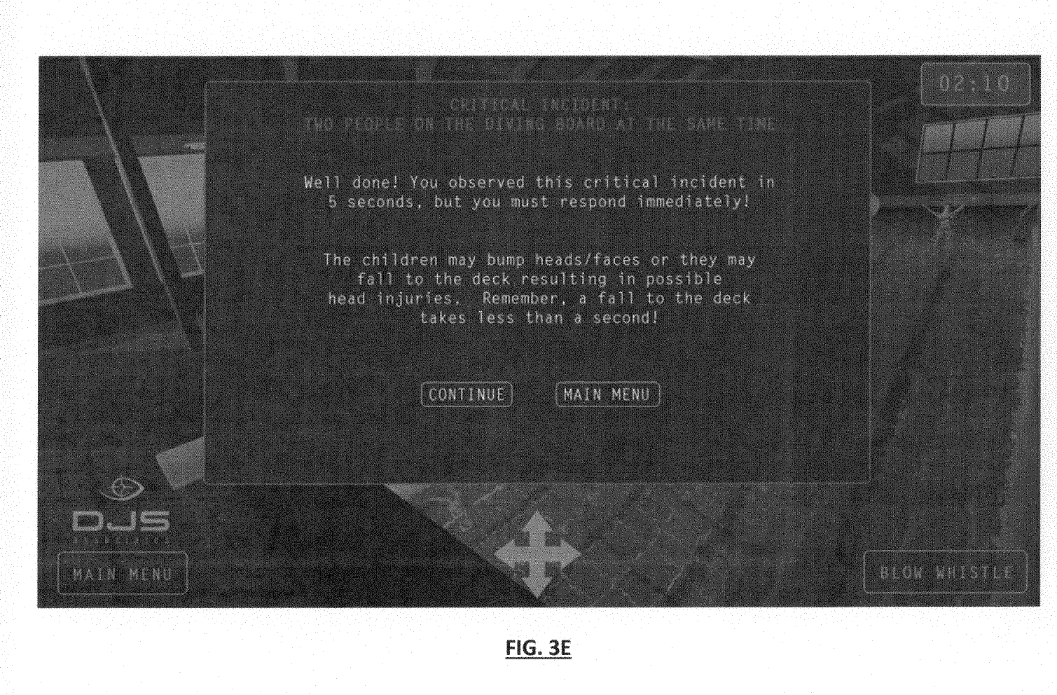

Referring to FIGS. 3A through 3E, another simulation is presented by example in the same water environment 12 and indoor pool 14 described above. In this simulation, however, two different individuals 16b and 16c are shown playing on and near a diving board at time 2:05. At time 2:10, however, one of the individuals 16b is shown on the diving board while the other individual 16c is still on the board, exhibiting an unsafe condition. FIG. 3C shows that the user has pushed the blow whistle button to call attention to the event and then highlights the individual 16b as the target of the unsafe event. As reflected in other examples, the user can select a false alarm interface to continue simulation. Otherwise, the result is that both the time and incident (unsafe situation) are reflected on the screen, such as shown in FIG. 3D, with the option to continue. Referring to FIG. 3E, as described above, feedback can be provided that indicates, for example, that the time elapsed was satisfactory and what adverse events might have been avoided. A score may be provided as well.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A system for three-dimensional simulation of a water environment in which one or more individuals are positioned in or around the water environment and then randomly presented in actual or potential distress situations, the system comprising:
means for presenting in three-dimensions a water environment with one or more random individuals presented in actual or potential distress situations,
means for permitting a system user to call attention to when the one or more individuals are in an actual or potential distress situation, and
means for detecting the response time from when the actual or potential distress situation begins to when the user calls attention to the one or more individuals in such an actual or potential distress situation;
wherein the system is configured so that one or more water environments can be presented and wherein the system is configured to measure and report appropriate response times, permitting the system to be used not only as a game but as a training module for users.

2. The system of claim 1, wherein the water environment is one of a pool or natural water body.

3. The system of claim 1, wherein the permitting means comprises a blow-whistle button that can be depressed or clicked.

4. The system of claim 1, wherein the detecting means comprises a clock visible to the user.

5. The system of claim 1, further comprising means for providing a score commensurate with the user's detection or lack of detection of an actual or potential distress situation and the elapsed time.

6. A method of presenting a simulation of a critical incident in a water environment, the method comprising:
presenting in three-dimensions a water environment with one or more random individuals presented in actual or potential distress situations,
permitting a user to call attention to when the one or more individuals are in an actual or potential distress situation, and
detecting the response time from when the actual or potential distress situation begins to when the user calls attention to the one or more individuals in such an actual or potential distress situation;
wherein the simulation is configured so that one or more water environments can be presented and wherein the simulation is configured to measure and report appropriate response times, permitting the simulation to be used not only as a game but as a training module for users.

7. The method of claim 6, wherein the water environment is one of a pool or natural water body.

8. The method of claim 6, wherein permitting comprises providing a blow-whistle button that can be depressed or clicked.

9. The method of claim 6, wherein detecting comprises providing a clock visible to the user.

10. The method of claim 6, further comprising providing a score commensurate with the user's detection or lack of detection of an actual or potential distress situation and the elapsed time
